(19) United States
(12) Patent Application Publication
(10) Pub. No.: US 2004/0101026 A1
(43) Pub. Date: May 27, 2004

(54) Inspired air temperature measuring device in respiratory circuit

(75) Inventors: Kazufuku Nitta, Saitama-ken (JP); Mitsuo Nemoto, Koshigaya-shi (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Metran Co., Ltd.

(21) Appl. No.: 10/717,722

(22) Filed: Nov. 20, 2003

Related U.S. Application Data
(63) Continuation of application No. PCT/JP02/04941, filed on May 22, 2002.

(30) Foreign Application Priority Data
May 23, 2001 (JP) 2001-154007

(51) Int. Cl. G01K 1/14; G01K 13/02

(52) U.S. Cl. 374/148

(57) ABSTRACT

The present invention provides a measurement device capable of measuring relatively accurately the temperature of inspired air used in artificial respiration.

This device measures the temperature of inspired air in a respiratory circuit that possesses an inspired air flow path. This device comprises a sensor that detects the temperature of inspired air inside the inspired air flow path, and a holder to hold the sensor in the inspired air flow path. The holder has a heat transfer-suppressing portion that prevents the transfer of heat from the exterior of the inspired air flow path to the sensor.

### BACKGROUND OF THE INVENTION

1. Field of the Invention

The present invention relates to a device that measures the temperature of inspired air used in artificial respiration and relates particularly to a device that measures the temperature of inspired air in a respiratory circuit.

2. Description of the Related Art

Generally, in an artificial respirator, a humidifier is installed in the middle of the inspired air flow path to provide the required humidity to the inspired air. However, the inspired air is sometimes cooled in the middle of the inspired air flow path by the room temperature. When this happens, not only the temperature of the inspired air itself is decreased, but the amount of saturated water vapor also decreases and gives rise to dew formation, generating the problem of the fear that by the time it is delivered to the patient, the humidity of the inspired air will have decreased. This problem cannot be ignored in cases where the patient is an infant, whose respiratory functions are vulnerable.

Therefore, in the prior art, decrease in inspired air temperature is avoided by installing a heater within the respirator flow path, to heat the inspired air. In this case, to appropriately control the temperature of the heater, a temperature sensor is installed to detect the inspired air temperature inside the flow path.

When an infant patient is accommodated inside an incubator, a heater to heat the interior of the incubator is installed, for example, an infra-red heater. Because of this, if a temperature sensor is installed inside the incubator, the temperature sensor is heated due to the heater, and there is the fear that the accuracy of detection deteriorates.

Therefore, conventionally, this problem is avoided by installing the temperature sensor outside the incubator. However, with this means, the sensor is detecting the temperature of inspired air at a position that is remote from the patient. Then, in order to correctly control the temperature and humidity of the inspired air that actually reaches the patient, the necessity arises of predicting the disturbance conditions (for example, cooling due to room temperature) exerted on the inspired air after it has been heated. Such controls are cumbersome, and in addition, there is the fear that responding to disturbances other than the ones that are predicted would be difficult. In other words, there is room for improvement in the prior art on this point.

The present invention was devised based on the circumstances, and its object is to provide a measurement device artificial that can measure relatively accurately the inspired air temperature used in respiration.

### SUMMARY OF THE INVENTION

The inspired air temperature measurement device of this invention possesses a sensor that detects the temperature of inspired air inside the inspired air flow path, and a holder that maintains the sensor in the inspired air flow path. The holder possesses a heat transfer suppressing portion that suppresses the heat transfer from the exterior of the inspired air flow path to the sensor.

The holder may be installed in the heating atmosphere. This heating atmosphere may be the inside of an incubator.

The constitution of the inspired air temperature measurement device of the present invention may be such that, in the device, the holder possesses a holder main body that is affixed to the respiratory circuit and an extended protrusion that is affixed to the holder main body, the extended protrusion extending from the holder main body towards the inside of the respirator flow path, the sensor being affixed to the extended protrusion and installed within the inspired air flow path, and the heat transfer suppressing portion being mounted onto the extended protrusion.

The heat transfer suppressing portion may be a curved portion that is part of the extended protrusion.

The heat transfer suppressing portion may be a spiral portion that is part of the extended protrusion.

The heat transfer suppressing portion may be a photo-reflective coating that is formed on the surface of the holder.

The heat transfer suppressing portion may be a cover that covers at least one portion of the surface of the holder.

An air layer may be formed between the cover and the holder.

The air layer may be closed with respect to the external space.

The heat transfer suppressing portion may be constituted by fins provided on the extended protrusion.

The holder main body and the extended protrusion may be made of one piece.

### BRIEF DESCRIPTION OF THE DRAWINGS

FIG. 1 is a view illustrating the schematic overall constitution of the inspired air temperature measurement device of the first embodiment of the present invention.

FIG. 2 is a schematic cross-sectional view showing an enlargement of the constitution in the vicinity of the holder that is used in the inspired air temperature measurement device of the first embodiment of the present invention.

FIG. 3 is a schematic cross-sectional view showing an enlargement of the constitution in the vicinity of the holder that is used in the inspired air temperature measurement device of the second embodiment of the present invention.

FIG. 4 is a schematic cross-sectional view showing an enlargement of the constitution in the vicinity of the holder that is used in the inspired air temperature measurement device of the third embodiment of the present invention.

FIG. 5 is a schematic cross-sectional view showing an enlargement of the constitution in the vicinity of the holder that is used in the inspired air temperature measurement device of the fourth embodiment of the present invention.

FIG. 6 is a schematic cross-sectional view showing an enlargement of the constitution in the vicinity of the holder that is used in the inspired air temperature measurement device of the fifth embodiment of the present invention.

FIG. 7 is a schematic cross-sectional view showing an enlargement of the constitution in the vicinity of the holder that is used in the inspired air temperature measurement device of the sixth embodiment of the present invention.

### DETAILED DESCRIPTION OF THE PREFERRED EMBODIMENTS

In the following, the device for measuring inspired air temperature related to the first embodiment of the present invention will be described using the attached drawings.

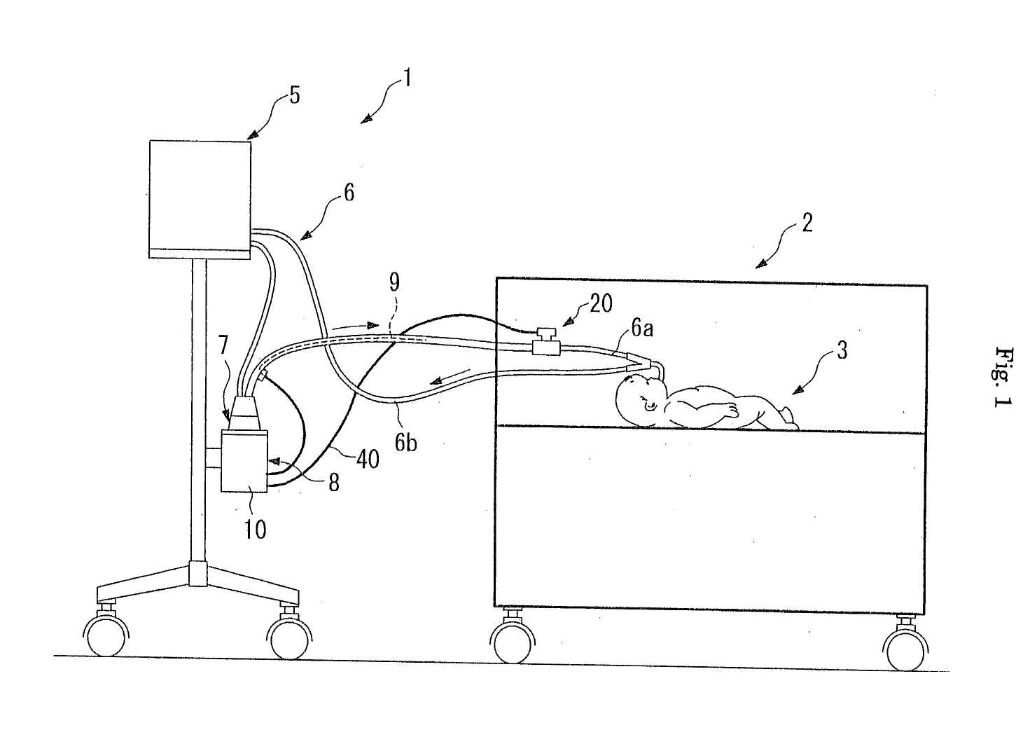

First, as one example in which this measurement device is used, the overall constitution of an artificial respirator for infant will be described based on FIG. 1. This artificial respirator 1 is connected to an incubator 2, and is arranged in such a way as to perform artificial respiration for patient 3 in the respirator 2. A heating means (not shown) such as an infra-red heater is installed inside the incubator 2.

The artificial respirator 1 is provided with a respirator main body 5, a respiratory circuit 6, a humidifier 7, a temperature measurement device (corresponding to the embodiment of the present invention) 8 and a heater 9.

The respirator main body 5 is provided with a required mechanism such as a pump, and is arranged in such a way that it can send/receive air to/from the patient 3 through a respiratory circuit 6.

The respiratory circuit 6 is provided with an inspired air flow path 6a and an expired air flow path 6b.

The humidifier 7 is installed in the middle of the inspired air flow path 6a. Here, a heating water-containing chamber is used as the humidifier 7. In the example shown here, the humidifier 7 and the temperature measurement device 8 are implemented by using the same chassis.

A heater 9 is installed inside the inspired air flow path 6a and on the upstream side of a sensor 30. The heater 9 can heat the inspired air by Joule heat generation.

The above constitution is substantially identical to the artificial respirator of the prior art.

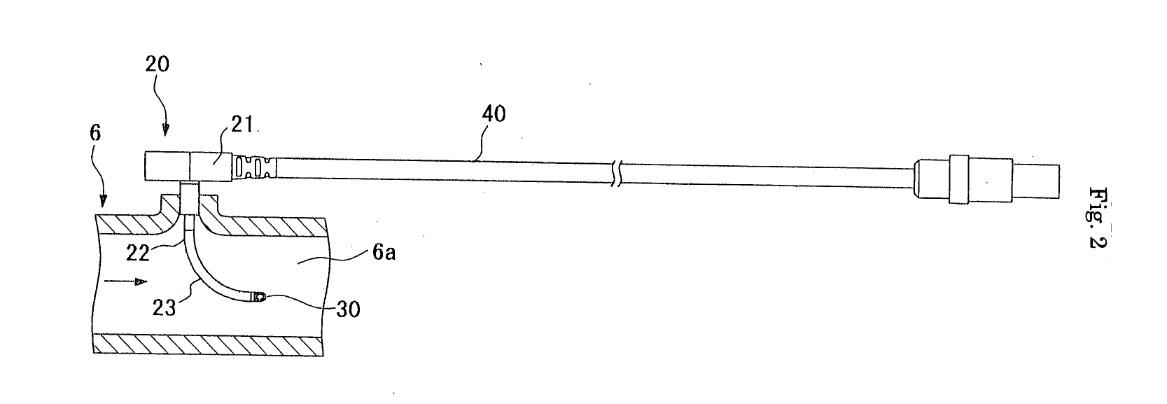

The temperature measurement device 8 corresponding to the embodiment of the present invention is provided with a measurement device main body 10, a holder 20, a sensor 30 for thermometry (see FIG. 2), and wiring 40. The measurement device main body 10 is arranged in such a way as to measure the inspired air temperature inside the inspired air flow path 6a based on the output of sensor 30 sent via the wiring 40, and control the temperature of the heater 9 in response to this inspired air temperature.

The holder 20 is installed inside the incubator 2, as shown in FIG. 1. As shown in FIG. 2, the holder 20 is provided with a holder main body 21, and an extended protrusion 22 that is affixed to this main body 21. The holder main body 21 is affixed to a fixation hole that is formed in the respiratory circuit 6. The extended protrusion 22 extends from the holder main body 21 towards the interior of the respirator flow path 6a. The sensor 30 is affixed in the vicinity of the tip of the extended protrusion 22, and installed inside the inspired air flow path 6a. The middle portion of the extended protrusion 22 is curved and forms a curved portion 23. In this embodiment, the curved portion 23 is the heat transfer suppressing portion of the present invention. It is preferred that the curving direction of the curved portion 23 be in the direction of heater 9 for a correct temperature measurement, but is not limited to this.

Since the sensor 30 and the wiring 40 are the same as in the prior art, detailed description will be omitted.

According to the temperature measurement device 8 of the present embodiment, since a curved portion (heat transfer prevention portion) 23 is implemented in the holding portion 20, the distance from the holder main body 21 to the sensor 30 can be made longer compared to the case where the curved portion 23 does not exist. In this way, the amount of heat radiation from the extended protrusion 22 due to the inspired air flowing inside the inspired air flow path 6a can be increased. Then, the amount of heat transfer from the holder main body 21, which is heated, for example, by the heating means inside the incubator 2, to the sensor 30 can be decreased compared to the prior art. Therefore, according to the present embodiment, even in cases where the sensor 30 is installed near the patient (for example, inside the incubator 2), it is possible to measure the inspired air temperature in the inspired air flow path with the sensor 30 relatively accurately. Therefore, there is the advantage that the temperature and the humidity of the inspired air supplied to the patient can be controlled accurately.

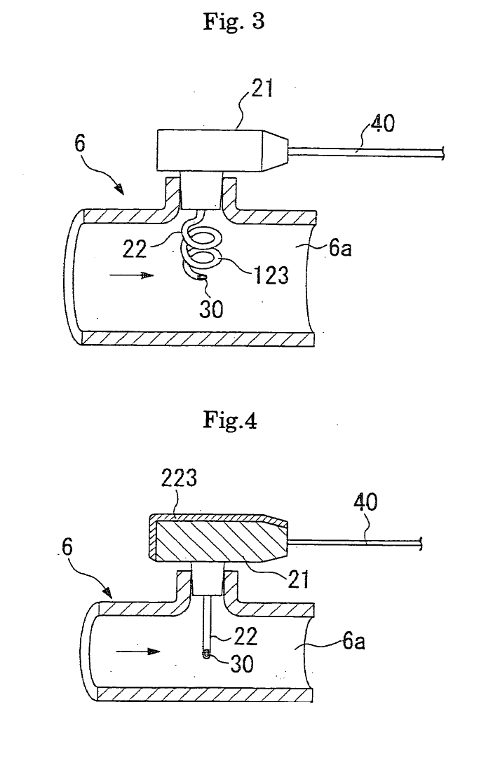

Next, the temperature measurement device related to the second embodiment of the present invention will be described using FIG. 3. In this embodiment, instead of the curved portion 23, a spiral portion 123 is implemented as part of the extended protrusion 22. The spiral portion 123 serves as the heat transfer suppressing portion of the present invention. Since the other constitutions and advantages of the present embodiment are essentially identical to the first embodiment, their description will be omitted.

Next, the temperature measurement device related to the third embodiment of the present invention will be described using FIG. 4. In this embodiment, a photo-reflective coating 223 is formed on the outer surface of the holder main body 21. The photo-reflective coating 223 is constructed from a material that has high reflectivity for light, particularly preferably infra-red radiation. The coating 223 serves as the heat transfer suppressing portion of the present invention. In addition, the extended protrusion 22 in FIG. 4 is a simple linear one. Since the other constitutions of the present embodiment are essentially identical to the first embodiment, their description will be omitted.

In the present embodiment, for example, the infra-red radiation radiated from the infra-red heater inside the incubator 2 can be effectively reflected by the coating 223. Then, it is possible to prevent heating of the holder main body 21, and decrease the amount of heat transfer from the exterior of the respiratory circuit 6 to the sensor 30. Since the other advantages are essentially identical to the first embodiment, their description will be omitted.

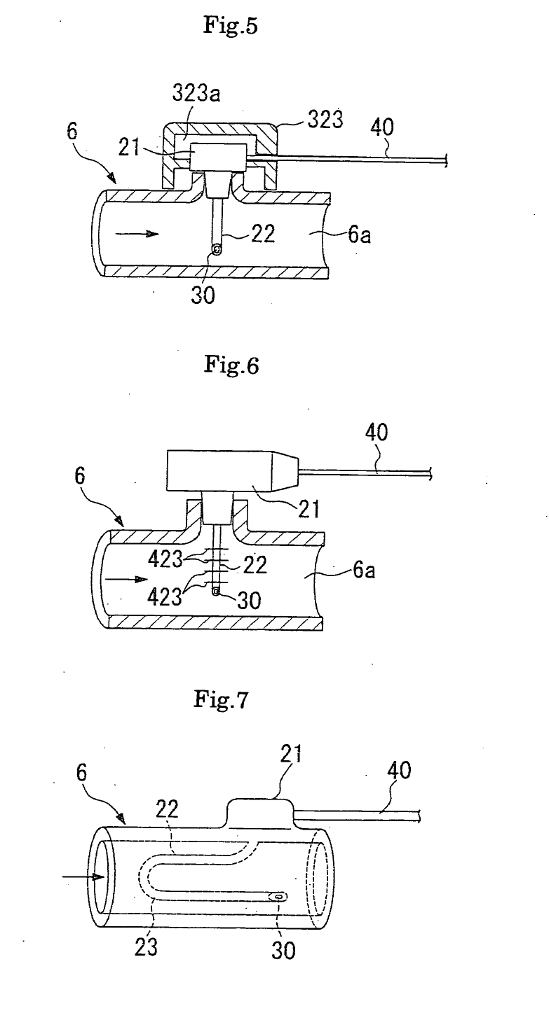

Next, the temperature measurement device related to the fourth embodiment of the present invention will be described using FIG. 5. In this embodiment, a cover 323 is affixed to the outside of the holder main body 21, which covers this holder main body 21. The cover 323 serves as the heat transfer suppressing portion of the present invention. Although in this embodiment, the cover 323 covers the entire upper surface of the holder main body 21, it may cover a portion thereof. An air layer 323a is formed inside the cover 323. The air layer 323a is closed (sealed) with respect to the space external to the cover 323. Since the other constitutions of the present embodiment are essentially identical to the first embodiment, their description will be omitted.

In the present embodiment, the amount of heat transfer to the holder main body 21 can be decreased by the cover 323. Then, the amount of heat transfer from the exterior of the respiratory circuit 6 to the sensor 30 can be decreased.

In addition, since the air layer 323a is installed in the cover 323, air in the present embodiment, from the heat insulation action of the air, the amount of heat transfer from the exterior to the sensor 30 can be further decreased. Since the other advantages of the present embodiment are essentially identical to the first embodiment, their description will be omitted.

Next, the temperature measurement device related to the fifth embodiment of the present invention will be described using FIG. 6. In this embodiment, fins 423 for heat radiation are installed in the middle portion of the extended protrusion 22. The fins 423 serve as the heat transfer suppressing portion of the present invention. Since the other constitutions of the present embodiment are essentially identical to the first embodiment, their description will be omitted.

In the present embodiment, the amount of heat transfer from the exterior of the respiratory circuit 6 to the sensor 30 can be decreased by the inspired air passing in the vicinity of the fins 423. Since the other advantages of the present embodiment are essentially identical to the first embodiment, their description will be omitted.

Next, the temperature measurement device related to the sixth embodiment of the present invention will be described using FIG. 7. In this embodiment, the holder main body 21 and the extended protrusion 22 form one piece. In addition, in this embodiment, the respiratory circuit 6 also forms one piece with them. Such a constitution may be realized through resin molding or by combining molded parts and adhering them together. In case the holder main body 21, the extended protrusion 22 and the respiratory circuit 6 are molded or formed as one piece, the constitution may be such that the respiratory circuit 6, which is the portion in the vicinity of the holder 20, is made as a separate piece from the other respiratory circuit portions, and connected as necessary to the other respiratory circuit portions. Since the other constitutions and advantages of the present embodiment are essentially identical to the first embodiment, the same reference numerals will be assigned and their description will be omitted.

In addition, the description of the embodiment is merely an example, and is not meant to demonstrate a constitution that is obligatory for the present invention. The constitution of each portion is not restricted to what has been previously mentioned, if it can achieve the purposes of the present invention. For example, in each embodiment, although the holder 20 is installed inside the heating atmosphere, it can also be installed in the cooling environment (for example in the room). In this case also, relatively accurate temperature measurement is possible with the same principle as previously described.

According to the present invention, a measurement device is provided that is capable of measuring relatively accurately the temperature of inspired air used in artificial respiration.

What is claimed is:

1. An inspired air temperature measurement device that is a device for measuring inspired air temperature inside a respiratory circuit having an air flow path, comprising a sensor to detect the temperature of inspired air inside the inspired air flow path, and a holder to hold the sensor in the inspired air flow path, the holder having a heat transfer suppressing portion that suppresses temperature transfer from the exterior of the inspired air flow path to the sensor.

2. The inspired air temperature measurement device of claim 1, wherein the holder is installed in a heating environment.

3. The inspired air temperature measurement device of claim 2, wherein the heating environment is the inside of an incubator.

4. The inspired air temperature measurement device of claim 1, wherein the holder has a holder main body that is affixed to the respiratory circuit, and an extended protrusion that is affixed to the holder main body, the extended protrusion extending from the holder main body towards the inside of the respirator flow path, the sensor being affixed to the extended protrusion and installed inside the inspired air flow path, and the heat transfer suppressing portion being formed on the extended protrusion.

5. The inspired air temperature measurement device of claim 4, wherein the heat transfer suppressing portion is a curved portion that is a portion of the extended protrusion.

6. The inspired air temperature measurement device of claim 4 wherein the heat transfer suppressing portion is a spiral portion that is a portion of the extended protrusion.

7. The inspired air temperature measurement device of claim 1, wherein the heat transfer suppressing portion is a photo-reflective coating that is formed on the surface of the holder.

8. The inspired air temperature measurement device of claim 1, wherein the heat transfer suppressing portion is a cover that covers at least a portion of the surface of the holder.

9. The inspired air temperature measurement device of claim 8, wherein an air layer is formed between the cover and the holder.

10. The inspired air temperature measurement device of claim 9, wherein the air layer is closed with respect to the external space.

11. The inspired air temperature measurement device of claim 4, wherein the heat transfer suppressing portion is constituted by fins provided on the extended protrusion.

12. The inspired air temperature measurement device of claim 1, wherein the holder main body and the extended protrusion are made into one piece.
